(19) United States
(12) Patent Application Publication
(10) Pub. No.: US 2006/0068113 A1
(43) Pub. Date: Mar. 30, 2006

(54) Method of applying viscous fluid material and apparatus therefor

(76) Inventors: Hitoshi Aoyama, Kanagawa-ken (JP); Hiroshi Todo, Chiba-ken (JP); Hiroyuki Takagi, Kanagawa-ken (JP)

Correspondence Address: WOOD, HERRON & EVANS, LLP (NORDSON), 2700 CAREW TOWER, 441 VINE STREET, CINCINNATI, OH, 45202, US

(21) Appl. No.: 10/532,881

(22) PCT Filed: Oct. 27, 2003
(86) PCT No.: PCT/JP03/13698

§ 371 Date: Apr. 27, 2005

(30) Foreign Application Priority Data
Oct. 29, 2002 (JP) 2002-314330

(51) Int. Cl. B05D 3/12; B05C 5/00

(52) U.S. Cl. 427/356; 118/300

(57) ABSTRACT

A method of applying a viscous fluid material for preventing a viscous fluid material (40) from accumulating on a contact type slot nozzle (30) when applying the viscous fluid material (40) onto an object to be applied (50) which has surface irregularities by using the contact type slot nozzle (30). The method of applying a viscous fluid material includes: moving the object (50) in a predetermined transport direction (X); bringing the nozzle (30) provided to a slot (35) into contact with the object (50) that is being moved; dispensing the viscous fluid material (40) from the slot (35) to apply the viscous fluid material (40) onto the object (50); and ejecting a heated compression gas on the downstream side of the slot (35) in the predetermined transport direction (X) to press the viscous fluid material (40) applied on the object (50) from the slot (35) against the object (50) by the ejected compression gas.

### TECHNICAL FIELD

The present invention relates to a method and apparatus for applying a viscous fluid material to an object which has surface irregularities by using a slot nozzle that is brought into contact with the object. In particular, the present invention relates to a method and apparatus for applying a viscous fluid material to an object by using a contact slot nozzle equipped with a self-cleaning air ejection mechanism.

### BACKGROUND ART

Conventionally, nozzles provided with a slot for dispensing hot melt adhesives are known (see, for example, JP 62-129177 A corresponding to U.S. Pat. No. 4,798,163 (Document 1)).

Further, there are slot coating guns which are brought into contact with a surface of a disposable diaper for applying a lotion to the surface. Some of the slot coating guns are equipped with a self-cleaning mechanism attached to the contact portion to prevent the lotion from sticking to the application surface of the gun (see, for example, Yoshiharu Kosaka “Application of a lotion to the surface of a disposable diaper which prevents skin roughness”, NONWOVENS REVIEW, September 1999, Vol. 10, No. 3, 43rd issue, p. 20-21 (Document 2)). In this way, there is devised a method of preventing lotion droplets from dropping onto the disposable diaper. However, slot coating guns for a lotion are not suitable for use in a method of contact-applying a high-viscosity molten material such as a hot melt adhesive to a non-woven fabric.

Further, when interrupting the supply of adhesives dispensed from a slot nozzle, a drooling or a tailing of the adhesives may occur due to poor adhesive cut-off. In view of this, there is known a nozzle device which supplies a jet air on the upstream side with respect to the transport direction of an object to be applied, in order to prevent the occurrence of a drooling or a tailing and achieve a sharp adhesive cut-off (see, for example, JP 4-66158 A (Document 3)).

Slot nozzles are suitable for planar application and, in particular, contact type slot nozzles are widely used due to their advantage that the application material does not easily scatter. However, the use of contact type slot nozzles has been limited to application of a material onto a web having a flat surface.

In the sanitary goods industry, an extremely large emphasis is placed on the soft touch feel of the products in recent years. Thus, among objects to be applied such as a disposable diaper or a sanitary napkin, those having a soft touch and large surface irregularities are coming into mainstream. That is, the surface of non-woven fabrics used for a disposable diaper or a sanitary napkin has irregularities by means of fluffing, or due to embossing by span bonding, heat sealing, or the like. When attempting to apply hot melt adhesives to a non-woven fabric having such surface irregularities by using a contact type slot nozzle, dripping of the hot melt adhesives occurs, resulting in an unsightly appearance. In addition, an object to be applied which is made from a soft material is also subject to a rather large extension, making it difficult to perform intermittent application due to the small tensile force acting in the mechanical direction during the application. It is to be noted that, although use of a non-contact type slot nozzle facilitates application of adhesives, the use of a non-contact type slot nozzle may instead involve scattering of the adhesives to the atmosphere to some extent. In view of this, the use of a contact type slot nozzle is being desired.

FIG. 6 is a view showing how a hot melt adhesive 140 is applied to a non-woven fabric 150 having surface irregularities by using a conventional contact type slot nozzle 130.

The contact type slot nozzle 130 includes a front blade 131 and a rear blade 132. A slot 135 is formed between the front blade 131 and the rear blade 132.

The non-woven fabric 150 is moved in a transport direction indicated by the arrow X in the figure.

The contact type slot nozzle 130 dispenses the hot melt adhesive 140 through the slot 135 while contacting the non-woven fabric 150 that is being moved. While the slot 135 is in contact with the non-woven fabric 150, a hot melt adhesive 140a is applied to the non-woven fabric 150 sufficiently. However, in a recess 150a of the non-woven fabric 150, a hot melt adhesive 140b dispensed from the slot 135 does not contact the bottom portion of the recess 150a and thus is not transferred to the non-woven fabric 150, adhering on the downstream side of the nozzle 130. A hot met adhesive 140c adhered on the downstream side of the nozzle 130 accumulates to form a build-up, causing dripping as the build-up adhesive drops off. Here, the accumulation of the hot melt adhesive on the nozzle which occurs during the application process using the contact type nozzle is referred to as the “build up”. The dripping thus caused results in a degraded appearance of the obtained product.

Alternatively, a construction shown in FIG. 7 may be adopted, in which a non-woven fabric 250 consists of two non-woven fabrics 250a and 250b, and includes a stretchable member 260 provided between the non-woven fabric 250a and the non-woven fabric 250b. In this case, a protrusion 250c is formed in the portion of the stretchable member 260.

FIG. 8 shows a state in which a hot melt adhesive 240 is applied to the non-woven fabric 250 by bringing a slot nozzle 230 into contact with the non-woven fabric while moving the non-woven fabric 250 in a transport direction indicated by the arrow X. Because the slot nozzle 230 is detached from the non-woven fabric 250 at positions outside both ends of the protrusion 250c, the hot melt adhesive 240 that is not transferred to the non-woven fabric 250 adheres and accumulates onto a surface of the slot nozzle 230 which is on the downstream side with respect to the transport direction. FIG. 9 is a view of the slot nozzle 230 as seen from the downstream side of the transport direction and along the arrow IX of FIG. 8. The hot melt adhesive 240 thus accumulated forms a build-up 240a, causing dripping as the build-up 240a drops off.

The slot coating gun having a self-cleaning mechanism which is disclosed in Document 2 is suitable for application of a low-viscosity liquid material such as a lotion. However, when attempting to apply a high-temperature, high-viscosity liquid material such as a hot melt adhesive by using the slot coating gun, there occurs a problem that the hot melt adhesive is cooled, making the slot coating gun unsuitable for application of a high-temperature, high-viscosity liquid material.

Further, while the slot nozzle described in Document 1 is widely used for a method of applying an application material onto a web in a planar fashion, the mode of application is limited to continuous application.

By providing such a slot nozzle with an open/close valve that allows for fast intermittent application of an application material, it is possible to apply the application material individually to only necessary locations, leading to a substantially reduced consumption of the application material and dramatically extended cutter life.

However, in the intermittent slot nozzle described above, a material that is formed at its rear lip edge during the application is drawn out upon stoppage of the application, which may cause drooling during the application or defective edges such as uneven edges at the end of the dispensing operation and drawing. Therefore, it is necessary to prevent the occurrence of drooling and defective edges by performing fine initial mechanical adjustments including installation adjustments such as adjustment of the distance between the web and the nozzle, the web tension, etc. and adjustment of the composition of the application material.

In the invention of Document 3, in order to remove a drooling or tailing part of adhesives generated upon interrupting the supply of the adhesives dispensed from a slot nozzle used for intermittent application, an air hole for ejecting air is provided on the upstream side of the slot nozzle with respect to the transport direction of an object to be applied. The drooling or tailing part of the adhesives is removed by thus supplying jet air from the air hole on the upstream side of a nozzle hole for dispensing the adhesives. However, the air hole is provided on the upstream side of the nozzle hole, and thus it is impossible to remove an adhesive build-up accumulated on the downstream side of the nozzle hole.

### DISCLOSURE OF THE INVENTION

In order to solve the above-mentioned problems, according to the present invention, there is provided a method of applying a viscous fluid material as described below.

That is, the method of applying a viscous fluid material to an object includes: moving the object in a predetermined transport direction; bringing a nozzle with a slot into contact with the moving object; dispensing the viscous fluid material from the slot to apply the viscous fluid material onto the object; and ejecting a heated compression gas downstream of the slot in the predetermined transport direction to press the viscous fluid material applied on the object from the slot against the object by the ejected compression gas.

By ejecting the heated compression gas on the downstream side of the slot, the accumulation of the viscous fluid material is prevented, thereby enabling uniform planar application of the viscous fluid material to the object.

As for the compression gas, a compression gas such as heated compression air may be directly introduced from the outside into the nozzle, or a heated compression gas may be introduced into the nozzle by way of a heater provided in the interior portion of a gun main body and a manifold. In this case, the heated compression gas introduced from the outside is used for application of a liquid and a water soluble resin, whereas the compression gas heated within the gun body is mainly used for application of a hot melt adhesive.

It is preferable that the compression gas be continuously ejected in a curtain-like fashion. The viscous fluid material, which tends to accumulate on the downstream-side rear edge portion of the nozzle, is blown toward the object by the flow of the compression gas continuously ejected from the downstream-side rear edge portion and thus does not accumulate on the downstream-side rear edge portion of the nozzle. Because the viscous fluid material does not accumulate on the downstream-side rear edge of the nozzle, drooling of the viscous fluid material and occurrence of defective edges at the end of the dispensing operation are eliminated.

### BRIEF DESCRIPTION OF THE DRAWINGS

FIG. 1 is a schematic diagram showing an applicator used for a method of applying a viscous fluid material according to the present invention.

FIG. 2 is a sectional perspective view of a nozzle.

FIG. 3 is a bottom view of the nozzle.

FIG. 4 is a view showing how the viscous fluid material is applied to an object to be applied according to the present invention.

FIG. 5 is a view showing how the viscous fluid material is applied to a recess formed in the surface of the object.

FIG. 6 is a view showing how to apply a hot melt adhesive to a non-woven fabric having surface irregularities by using a conventional contact type slot nozzle.

FIG. 7 is a sectional view of a non-woven fabric consisting of two non-woven fabrics having a stretchable member arranged therebetween.

FIG. 8 is a view showing how the hot melt adhesives are applied to the non-woven fabric having a protrusion by using a conventional slot nozzle.

FIG. 9 is a view of the slot nozzle as seen from the downstream side of a transport direction and along the arrow IX of FIG. 8.

### BEST MODE FOR CARRYING OUT THE INVENTION

Hereinbelow, the present invention is described based on its preferred embodiment with reference to the drawings.

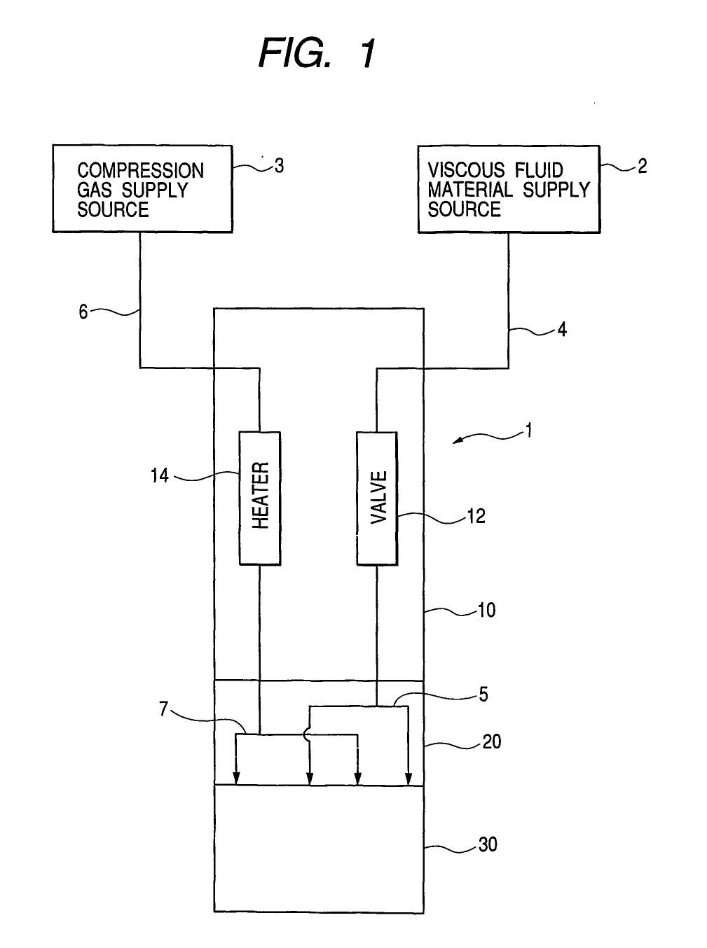

FIG. 1 is a schematic diagram showing an applicator 1 used for a method of applying a viscous fluid material according to the present invention. The applicator 1 is connected to a viscous fluid material supply source 2 for supplying a viscous fluid material such as a hot melt adhesive, and to a compression gas supply source 3 for supplying a compression gas such as compressed air. The applicator 1 includes a gun body 10, a manifold 20, and a nozzle 30. Provided in the interior portion of the gun body 10 is a valve 12 for controlling the start and stoppage of dispensing of a viscous fluid material that is dispensed from the nozzle 30. The valve 12 is in fluid communication with the viscous fluid material supply source 2 by way of a conduit 4. The viscous fluid material exiting the valve 12 is distributed into the nozzle 30 substantially uniformly by way of a conduit 5 provided in the manifold 20. Provided in the interior portion of the gun body 10 is a heater 14 for heating a compression gas ejected from the nozzle 30. The heater 14 is in fluid communication with the compression gas supply source 3 by way of a conduit 6. The compression gas from the heater 14 is distributed into the nozzle 30 substantially uniformly by way of a conduit 7 provided in the manifold 20.

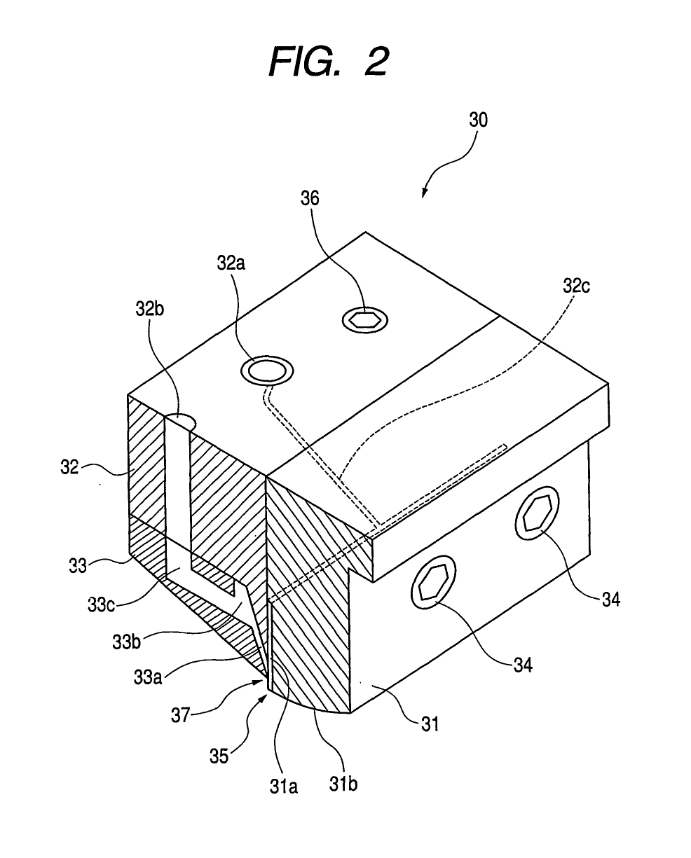

FIG. 2 is a sectional perspective view of the nozzle 30. The nozzle 30 includes a front blade 31, a rear blade 32, and an air lip 33. A rectangular depression 31a is formed on one surface of the front blade 31. The depression 31a is open on a surface 31b of the front blade 31 which is brought into contact with an object to be applied. A slot 35 for dispensing a viscous fluid material is defined when the front blade 31 and the rear blade 32 are fastened together with screws 34. It is to be noted that the slot may also be formed by providing a pattern blade (not shown) between the front blade 31 and the rear blade 32. The depression 31a is in fluid communication with a port 32a provided in the rear blade 32, by way of a conduit 32c provided in the rear blade 32. The port 32a is connected to the conduit 5 provided in the manifold 20, for receiving the viscous fluid material.

A rectangular recess 33a is provided in one side of the air lip 33. A screw 36 fastens the air lip 33 and the rear blade 32 to form an opening 37 for ejecting a compression gas. The recess 33a is communicated with the port 32b of the rear blade 32 through an air chamber 33b of the air lip 33 and a conduit 33c. The port 32b is connected to the conduit 7 of the manifold 20 and receives the compression gas.

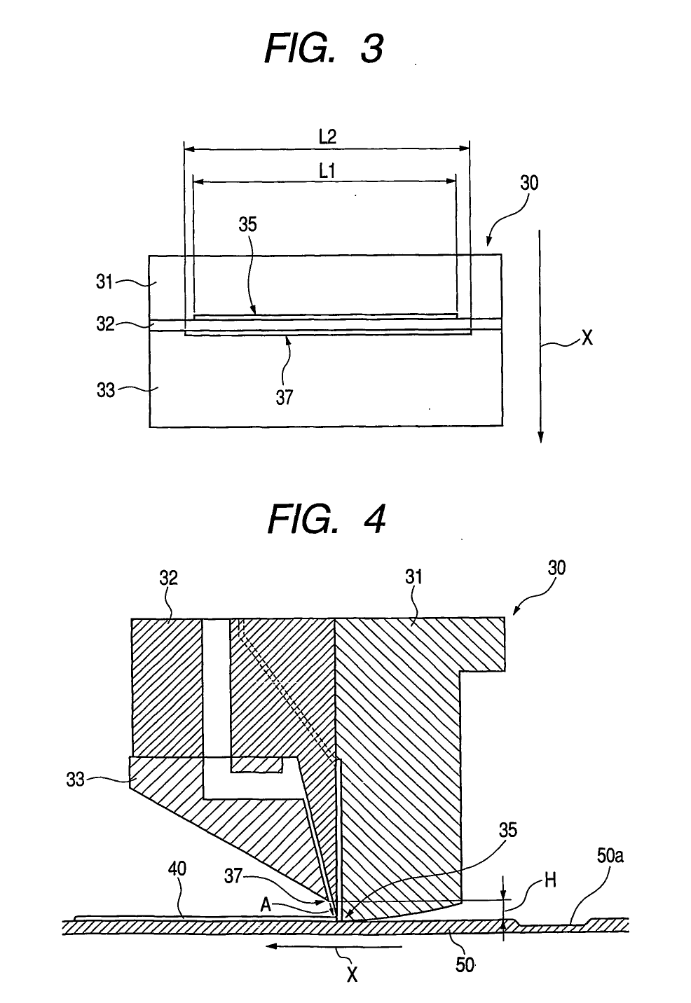

FIG. 3 is a bottom view of the nozzle 30. In a transport direction, which is indicated by the arrow X, of an object to be applied with the viscous fluid, the opening 37 for the compression gas is arranged downstream of the slot 35 for the viscous fluid material. The length L2 of the opening 37 in a direction substantially perpendicular to the transport direction of the object which is indicated by the arrow X is set to be about 0.1 to 5 mm larger than the length L1 of the slot 35. By setting the length L2 to be larger than the length L1 of the opening 37, the viscous fluid material dispensed from the ends of the slot 35 is reliably prevented from adhering to the rear blade 32 and the air lip 33.

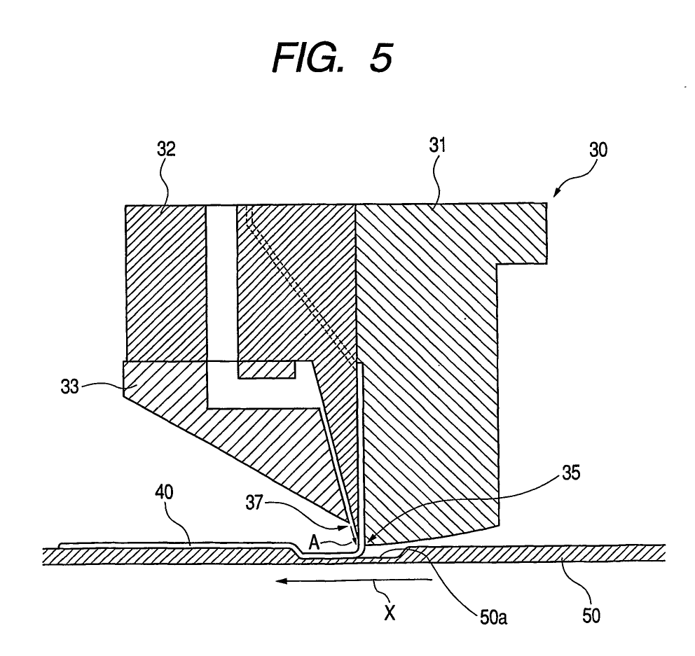

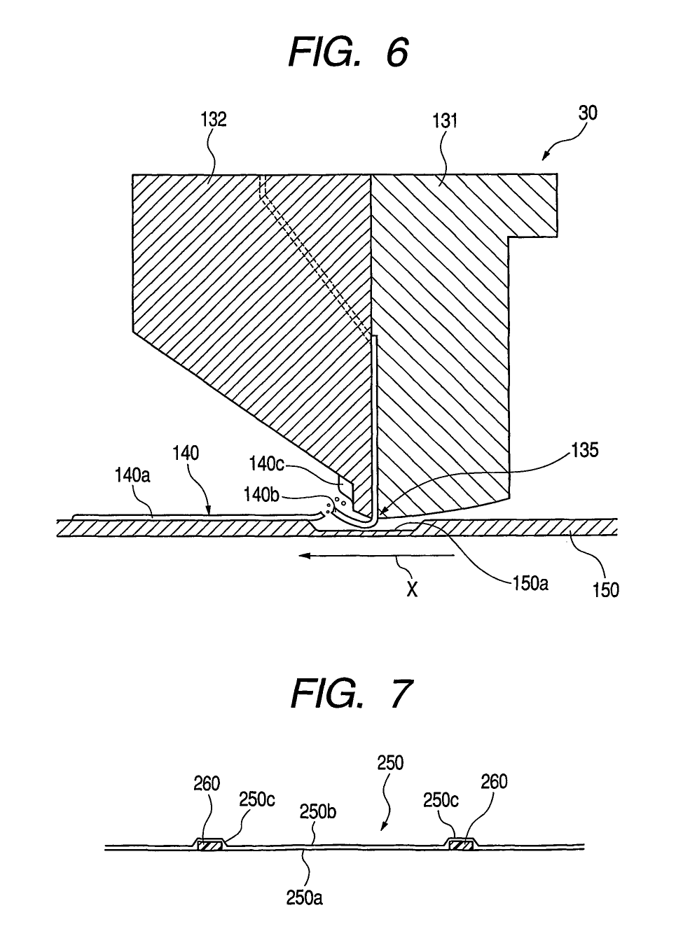

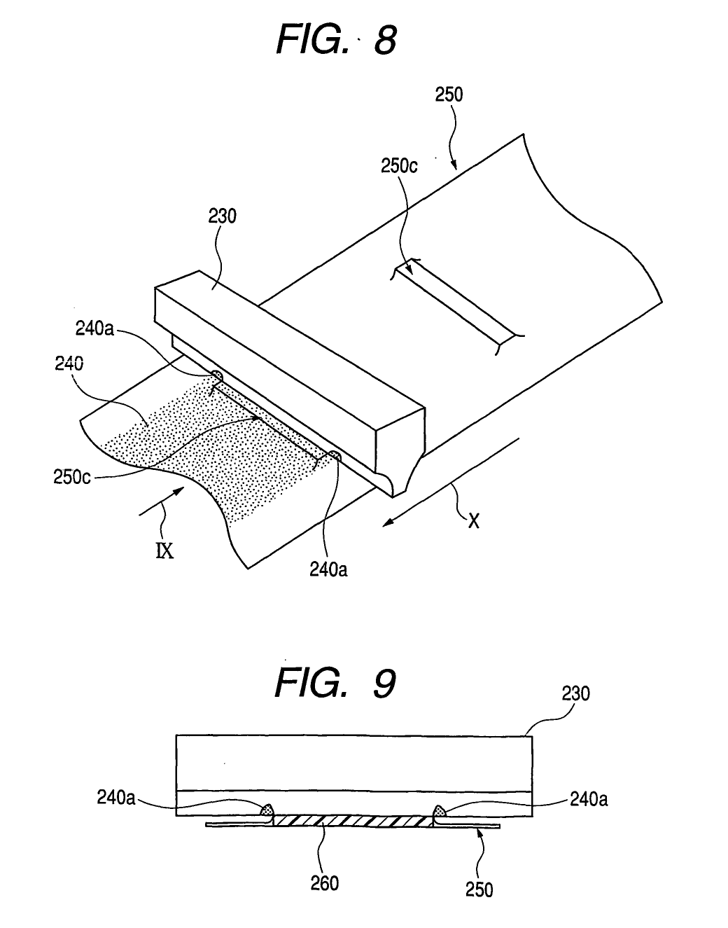

FIGS. 4 and 5 are views showing how a viscous fluid material 40 is applied to an object to be applied 50 according to the present invention. The object 50 consists of a non-woven fabric such as a disposable diaper or a sanitary napkin. The surface of the object 50 has irregularities by means of fluffing, or due to embossing by span bonding, heat sealing, or the like.

Referring to FIG. 4, the object 50 is moved in a transport direction indicated by the arrow X. The nozzle 30 is arranged so as to be in contact with the object 50 that is being moved. The viscous fluid material 40 is dispensed from the slot 35 of the nozzle 30, to be applied onto the object 50 in a planar fashion. A heated compression gas is ejected from the opening 37 toward the viscous fluid material 40 applied onto the object 50, in a manner as indicated by the arrow A. The viscous fluid material applied onto the object is pressed against the object by the ejected compression gas. It is to be noted that the opening 37 is arranged at a position higher than the slot 35 by a distance H. The distance H may be several tens μm to several mm. The temperature of the compression gas supplied to the opening 37 is adjusted to be about 10 to 20° C. higher than the temperature of the viscous fluid material (in the case where the viscous fluid material is a hot melt adhesive or the like, the melting temperature thereof is 50 to 250° C.).

FIG. 5 shows how the viscous fluid material 40 is applied to a recess 50a formed on the surface of the object 50. The viscous fluid material 40 dispensed from the slot 35 is pushed into the recess 50a by a heated compression gas A ejected from the opening 37 that is arranged downstream of the slot 35 with respect to the transport direction X of the object, to be pressed against the object 50. Therefore, the viscous fluid material 40 is reliably applied to the object 50 even in the recess 50a, thereby preventing the viscous fluid material 40 from adhering to the rear blade 32 or the air lip 33. Hence, there is obtained an effect of eliminating the problem in the conventional art in which the adhering viscous fluid material accumulates and forms a build-up to cause dripping as the build-up material drops off.

It is to be noted that the pressure of the compression gas supplied to the opening 37 is preferably adjusted to be about 0.05×10⁵ Pa to 3.0×10⁵ Pa higher than the atmospheric pressure. This is because if the pressure of the compression gas is lower than 0.05×10⁵ Pa then the viscous fluid material 40 dispensed from the slot 35 cannot be pushed into the recess 50a with reliability. On the other hand, if the pressure of the compression gas is greater than 3.0×10⁵ Pa, the compression gas blows off the viscous fluid material 40 dispensed from the slot 35, making it impossible to apply the viscous fluid material 40 to the object 50.

As the compression gas, while compressed air is used normally such as when the viscous fluid material 40 dispensed from the slot 35 is, for instance, a hot melt adhesive, various types of gas may be used as appropriate according to the properties and characteristics of the viscous fluid material 40 to be dispensed. For instance, in the case where the viscous fluid material 40 is flammable, a compressed inert gas such as a nitrogen gas or a carbon dioxide gas may be used.

As is apparent from the foregoing description, according to the present invention, the viscous fluid material dispensed from the slot is pushed into the recess formed in the object which has surface irregularities, by means of the heated compression gas ejected from the opening provided downstream of the slot, thereby effecting application of the viscous fluid material with reliability. Therefore, it is possible to prevent the viscous fluid material from adhering and accumulating onto the nozzle to form a build-up. Hence, there is obtained an effect of eliminating the problem in the prior art, namely the dripping of the build-up viscous fluid material.

Further, according to the present invention, the following additional effects may be attained. That is, in the case of a porous web material, the curtain-like viscous fluid material which is guided by the compression gas is diffused into the deep layer of the porous web material (enhanced adhesion force in the case where adhesives are applied). In the case of a stepped web or a web with large surface irregularities, the viscous fluid material to be applied to the web that is in contact with the slot nozzle can be accurately applied to even those portions of the web which are situated away from the slot nozzle.

It is to be noted that the same effects can be attained even if the slot and the opening are each replaced by an aggregate of multiple holes.

1. A method of applying a viscous fluid material to an object, comprising:
moving the object in a predetermined direction;
bringing a nozzle provided with a slot into contact with the moving object;
dispensing the viscous fluid material from the slot to apply the viscous fluid material onto the object; and
discharging a heated compression gas downstream of the slot in the predetermined direction to force the viscous fluid material against the object.

2. A method according to claim 1, wherein a surface of the object includes a recess, and the method further comprises:
forcing the viscous fluid material into the recess with the heated compression gas.

3. A method according to 1 wherein discharging the heated compression gas further comprises:
discharging a flow of the compression gas having a width larger than a length of the slot in a direction substantially perpendicular to the predetermined direction.

4. A method according to claim 1, wherein discharging the heated compression gas further comprises:
discharging the compression gas from an opening directed away from the object.

5. An apparatus for applying a viscous fluid material to an object, comprising:
a nozzle capable of contacting the object, the object movable in a predetermined direction;
a gun body supporting said nozzle, said gun body including a fluid passage for supplying the viscous fluid material to said nozzle and an air passage for supplying a compression gas to said nozzle; and
a heater coupled with said gun body for heating the compression gas,
wherein said nozzle is provided with a slot for dispensing the viscous fluid material onto the object and an opening positioned downstream of said slot in the predetermined direction for discharging the heated compression gas against the viscous fluid material on the object thereby forcing the viscous fluid material against the object.

6. A nozzle for applying a viscous fluid material to an object, the object being moved in a predetermined direction, wherein said nozzle is adapted to be attached to a manifold which receives a compression gas heated by a heater coupled with a gun body adapted to carry said nozzle, and wherein said nozzle is provided with a slot for dispensing the viscous fluid material and an opening positioned downstream of said slot in the predetermined direction for discharging the heated compression gas.
